(19) United States
(12) Patent Application Publication
(10) Pub. No.: US 2024/0396042 A1
(43) Pub. Date: Nov. 28, 2024

(54) LITHIUM-ION BATTERY COMPONENT WITH MULTI-LAYER ELECTRODE

(71) Applicant: FORD GLOBAL TECHNOLOGIES, LLC, Dearborn, MI (US)

(72) Inventors: Wei Xu, Westland, MI (US); Insik Jeon, Novi, MI (US); Feng Li, Troy, MI (US); Michael Lerner, Corvallis, OR (US)

(21) Appl. No.: 18/324,210

(22) Filed: May 26, 2023

(51) Int. Cl. H01M 4/587; H01M 4/04; H01M 4/133; H01M 4/134; H01M 4/38; H01M 10/0525

(52) U.S. Cl. CPC H01M 4/587; H01M 4/0404; H01M 4/133; H01M 4/134; H01M 4/386; H01M 10/0525

(57) ABSTRACT

This disclosure relates to a lithium-ion battery with an enhanced electrode structure and methods for forming such an electrode structure. The electrode may comprise a metal current collector and a multi-layered active material coated thereon, which includes a discrete graphite-rich and a discrete silicon-rich layer. The silicon-rich layer is positioned between and in direct contact with the metal current collector and the graphite-rich layer.

### TECHNICAL FIELD

The disclosure relates to electrode materials for lithium-ion batteries.

### BACKGROUND

Lithium-ion batteries are widely used in various applications. One of the contributors to lithium-ion battery performance is the electrode structure, which plays a role in determining cell performance such as energy density, power density, and cycle life of the battery.

Graphite is commonly used as an anode material in lithium-ion batteries due to its low lithiation potential and reasonable capacity, high electrical conductivity, and wide availability. Graphite, however, has been developed close to the theoretical capacity and energy density maximum, so significant changes in cell performance may require the use of new and/or different anode materials.

Silicon-based materials such as silicon oxides, silicon nanoparticles, and silicon/carbon composites have been considered as promising anode materials due to their high theoretical capacities, but lithiation of silicon domains results in expansion of the material, and de-lithiation in a corresponding contraction. This volume change may cause mechanical degradation of the anode and capacity loss during cycling. While other materials undergo volume changes upon lithiation, the effect is very large for silicon lithiation, and these materials often exhibit poor cycling performance.

### SUMMARY

This disclosure in one embodiment provides a lithium-ion battery comprising an electrode having a metal current collector and a multi-layered active material coated thereon. The multi-layered active material includes a discrete graphite-rich layer of at least 85 wt % graphite and a discrete silicon-rich layer of at least 15 wt % silicon-based material between and in direct contact with the metal current collector and graphite-rich layer such that the silicon-rich layer is adhered to the metal current collector and with the graphite-rich layer. In other embodiments the silicon-rich layer is of at least 20 wt % silicon-based material.

In one embodiment, the graphite-rich layer is free of silicon-based materials. In another embodiment, the silicon-rich layer is a molecularly crosslinked silicon-rich layer. In yet another embodiment, the silicon-based material comprises silicon carbide or silicon monoxide. In a further embodiment, the metal current collector is a metal foil.

The disclosure also provides an electrode comprising a metal current collector and a multi-layered active material coated thereon. The multi-layered active material includes a discrete layer of graphite particles suspended in a crosslinked binder and a discrete layer of silicon-based material particles suspended in a crosslinked binder, which is disposed between the metal current collector and the layer of graphite particles. The layers define an interface region where presence of the silicon-based material particles disrupts the in-plane alignment of the graphite particles. The layer of graphite particles comprises at least 85 wt % graphite, and the layer of silicon-based material particles comprises at least 15 wt % silicon-based material. In other embodiments the silicon-rich layer is of at least 20 wt % silicon-based material.

The disclosure provides a method for forming an electrode. The method comprises depositing a silicon-based slurry containing at least 15 wt % silicon-based material onto a metal current collector and drying to form a cured crosslinked layer. The method further includes depositing a top layer of graphite-based slurry containing at least 85 wt % graphite on the cured crosslinked layer and drying to form a cured top crosslinked layer. In other embodiments, a silicon-rich layer is of at least 20 wt % silicon-based material and/or the layers define an interface region in which presence of the silicon-based material particles disrupts the in-plane alignment of the graphite particles.

### BRIEF DESCRIPTION OF THE DRAWINGS

FIG. 1 is a schematic cross-sectional view of an electrode structure according to one embodiment; and

FIG. 2 is a schematic cross-sectional view of an electrode structure according to another embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Silicon oxide or silicon carbon composite materials (silicon X materials) have been developed that offer increased anode energy density compared to graphite, typically 800-1800 mAh/g, while significantly decreasing, relative to elemental silicon silicon, the amount of electrode swelling, anode or electrolyte degradation that can lead to irreversible capacity, gas formation and material fragmentation, and rapid cycle life loss. These silicon X active materials maintain an electrochemical activity similar to silicon in that they are conversion materials that reversibly form a lithiated silicon alloy when reduced in an electrochemical cell. These materials, however, either use oxide or a carbon substrate as matrices to facilitate performance in cells. Often these silicon X materials are blended with graphite to further facilitate cycle life and electrode stability, accepting a tradeoff between anode energy density and cell cycle life and anode stability.

This disclosure relates to lithium-ion batteries having an enhanced electrode structure and methods for forming such an electrode structure. In certain examples, a lithium-ion battery is provided with an electrode that includes a metal current collector and a multi-layered active material coated thereon. The multi-layered active material comprises a discrete graphite-rich layer and a discrete silicon-rich layer, which offers increased electrochemical performance, energy density, and cycle life compared to conventional lithium-ion batteries.

In the enhanced electrode structure, the active material comprises both silicon particles and graphite particles. At least a certain wt % of silicon particles are incorporated into the silicon-rich layer, while at least a certain wt % of graphite particles are incorporated into the graphite-rich layer.

The binder material in the multi-layered anode helps in maintaining the mechanical and structural integrity of the electrode. In some embodiments, the binder material comprises cross-linkers, which enhance the adhesion between the particles and the current collector, as well as between the silicon-rich layer and the graphite-rich layer. The cross-linked binder also contributes to mitigating mechanical stress induced by volume expansion and contraction of the silicon particles during charge and discharge cycles.

The expansion of silicon particles during charge and discharge cycles is a well-known phenomenon that can cause capacity loss and mechanical degradation in lithium-ion batteries. As it will be appreciated by one skilled in the art, a novel feature of the disclosure is the disruption of the in-plane alignment of graphite particles, which is achieved by the presence of silicon-based material particles at the interface region between the graphite-rich layer and the silicon-rich layer. This disruption helps to prevent the propagation of the expansion effects of the silicon particles throughout the graphite layer.

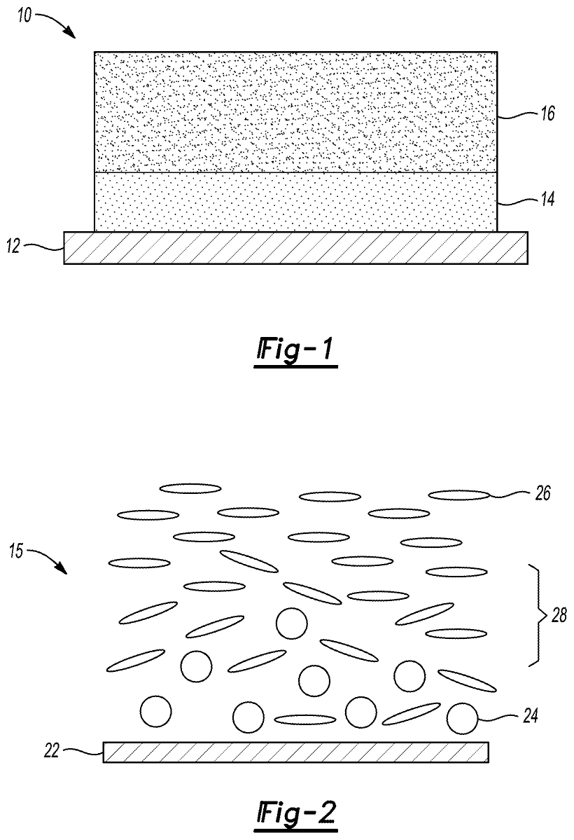

FIG. 1 is a schematic cross-sectional view of an electrode structure 10 according to one embodiment. The electrode structure 10 comprises a metal current collector 12, a first discrete silicon-rich layer 14, and a top discrete graphite-rich layer 16.

The metal current collector 12 may be made from materials such as copper, aluminum, or other suitable metal or metal alloys. The first discrete silicon-rich layer 14 is adhered to the metal current collector 12 and includes at least 15 wt % silicon-based material, which can be silicon carbide, silicon monoxide, or other suitable silicon-based materials. The top discrete graphite-rich layer 16 is in direct contact with the first discrete silicon-rich layer 14 and includes at least 85 wt % graphite. However, in certain embodiments the silicon-rich layer is of at least 20 wt % silicon-based material, further facilitating the electrode's performance.

FIG. 2 is a schematic cross-sectional view of an electrode structure 15 according to another embodiment. The electrode structure 15 comprises a metal current collector 22, a first layer 24 containing silicon particles, and a top layer 26 containing graphite particles.

The metal current collector 22 may be made from materials such as copper, aluminum, or other suitable metals or metal alloys. The first layer 24, which includes silicon particles, is formed on the current collector 22. The silicon particles in the first layer 24 can be suspended in a crosslinked binder material. The top layer 26, which includes graphite particles, is formed on the first layer 24. The graphite particles in the top layer 26 can also be suspended in a crosslinked binder material. At the interface region 28 between the first layer 24 and top layer 26, the presence of silicon particles disrupts the orientation of the graphite particles.

This disclosure thus contemplates forming a multilayer anode structure that blends silicon X and graphite active materials, where the first deposited layer on the metal current collector is a blend of silicon X and graphite active materials with a relatively high silicon X content (greater than 5 wt % silicon X, and especially greater than 20 wt % silicon X) and the outer layer or layers are comprised of a graphite active material with less than 15 wt %, or no silicon X content. All these layers also contain binder, and sometimes a conducting additive and other components that produce a functional electrode. Each layer may be coated by placing a slurry on the electrode surface and then drying. Each deposited layer may be 5-100 um in thickness.

This disclosure also contemplates stabilization of the sublayer by crosslinking prior to coating the overlayer. Crosslinking can be accomplished by adding molecular crosslinkers either into the slurry or onto the layer after coating, and subsequently generating the chemical crosslinks with either a chemical reagent, ultra violet light, or thermal process. This enables the formation of the multi-layered coated anode by preventing the re-dissolution or significant swelling of a coated layer when depositing a new layer.

One example of this crosslinking chemistry is to use either dipentaerythritol penta/hexa-acrylate or tetramethylolmethane tetraacrylate as molecular crosslinkers that form crosslinks after reaction with a free-radical source such as benzoyl peroxide. The crosslinkers and activator may be added during slurry coating or after the coating is applied. Typical crosslink densities may be 0.5-4%. Additional layers may then be applied without dissolution or significant swelling of the crosslinked layer.

The proposed multilayer approach may show different performance over a single layer by embedding the silicon X-rich layer within a strongly bound layer that is adjacent to the current collector. This can reduce the sublayer swelling and reduce loss of electrical contact to the silicon X particles.

The proposed multilayer approach may also produce an electrode in which the average alignment of graphite particles is decreased when compared to an anode with only graphite or a single-layer blend of graphite and silicon X active materials. This effect occurs due to the relatively higher silicon X particle presence in the sublayer. Silicon X particles are not layered and are relatively non-deformable and isotropic, which decreases the ability for compression to induce alignment in this sublayer. This can also reduce subsequent alignment in overlayers. The overall decrease in graphene sheet alignment results in less anisotropic cell swelling perpendicular to the cell stacking direction, as well as a less tortuous path for lithium ion migration through the wetted electrode, and thereby electrochemical performance benefits for the anode.

Other solutions to facilitate performance of silicon X-graphite blend anodes may involve replacing the carboxymethylcellulose/styrene-butadiene binder system with a less flexible binder such as polyacrylic or polyurethane.

The proposed arrangements may maintain closer contact of the silicon X to the current collector, provide a simple way to optimize the silicon X-graphite layer mechanical properties by changing the crosslink density, and reduce overall graphite particle alignment in the anode layer.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery comprising:
an electrode having a metal current collector and a multi-layered active material coated thereon that includes a discrete graphite-rich layer of at least 85 wt % graphite and a discrete silicon-rich layer of at least 15 wt % silicon-based material between and in direct contact with the metal current collector and graphite-rich layer such that the silicon-rich layer is adhered to the metal current collector and with the graphite-rich layer.

2. The lithium-ion battery of claim 1, wherein the silicon-rich layer is of at least 20 wt % silicon-based material.

3. The lithium-ion battery of claim 1, wherein the graphite-rich layer is free of silicon-based material.

4. The lithium-ion battery of claim 1, wherein the silicon-rich layer is a molecularly crosslinked silicon-rich layer.

5. The lithium-ion battery of claim 1, wherein the silicon-based material is silicon carbide or silicon monoxide.

6. The lithium-ion battery of claim 1, wherein the metal current collector is a metal foil.

7. An electrode comprising:
a metal current collector and a multi-layered active material coated thereon that includes a discrete layer of graphite particles suspended in a crosslinked binder and a discrete layer of silicon-based material particles suspended in a crosslinked binder and disposed between the metal current collector and the layer of graphite particles, the layers defining an interface region in which presence of the silicon-based material particles disrupts in-plane alignment of the graphite particles, the layer of graphite particles being at least 85 wt % graphite, and the layer of silicon-based material particles being at least 15 wt % silicon-based material.

8. The electrode of claim 7, wherein the layer of silicon-based material particles is of at least 20 wt % silicon-based material.

9. The electrode of claim 7, wherein the layer of graphite particles is free of silicon-based materials.

10. The electrode of claim 7, wherein the metal current collector is a metal foil.

11. A method for forming an electrode, comprising:
depositing a silicon-based slurry, containing at least 15 wt % silicon-based material, onto a metal current collector;
drying to form a cured crosslinked layer;
depositing a top layer of graphite-based slurry, containing at least 85 wt % graphite, on the cured crosslinked layer; and
drying to form a cured top crosslinked layer.

12. The method of claim 11, wherein the cured crosslinked layer is of at least 20 wt % silicon-based material.

13. The method of claim 11, wherein the layers define an interface region in which presence of silicon-based material particles disrupts in-plane alignment of graphite particles.

14. The method of claim 11, wherein the current collector is a metal foil.

15. The method of claim 11, wherein the cured top crosslinked layer is free of silicon-based materials.
